(19) United States
(12) Patent Application Publication
(10) Pub. No.: US 2006/0259224 A1
(43) Pub. Date: Nov. 16, 2006

(54) Method for regulating the dynamic drive of motor vehicles

(76) Inventors: Egon Auer, Bregenz (AT); Horst Krimmel, Tettnang (DE)

Correspondence Address: DAVIS & BUJOLD, P.L.L.C., 112 PLEASANT STREET, CONCORD, NH, 03301, US

(21) Appl. No.: 11/407,377

(22) Filed: Apr. 19, 2006

(30) Foreign Application Priority Data
Apr. 20, 2005 (DE) 102005018519.3

(51) Int. Cl. G06G 7/76

(52) U.S. Cl. 701/72; 701/70

(57) ABSTRACT

A method of regulating a dynamic drive of a motor vehicle. The regulation of the dynamic drive is based on the measured transverse acceleration of the vehicle, the difference A between the calculated transverse acceleration and the measured transverse acceleration is used as a criterion for the convertibility of the driver's wish under the actual driving conditions and, as a function of the difference, an additional positive or negative value steering wheel angle is superimposed on the driver's wish, that is, on the steering angle preset by the driver.

This application claims priority from German Application Serial No. 10 2005 018 519.3 filed Apr. 20, 2005.

### FIELD OF THE INVENTION

This invention relates to a method for regulating the dynamic drive of motor vehicles.

### BACKGROUND OF THE INVENTION

In production vehicles, the current regulations of dynamic drive are usually based on parameters such as the yawing rate of the vehicle and the floating angle of the vehicle which are used to form corresponding control signals.

DE 197 51 227 A1, for example, discloses a method and a device for operating a steering system of a motor vehicle and having at least one steerable wheel, one adjusting mechanism and one overlay transmission. Within the scope of the method for operating the steering system, a yawing parameter is detected which represents the yawing motion of the vehicle and, in the presence of a certain driving state, a control signal is formed which depends at least one the yawing parameter and controls the adjusting mechanism. Also determined is a parameter representative of the braking state of the vehicle and used to detect driving states. Thereby are to be obtained the yawing characteristics of the vehicle, especially in case of ABS brakings, in which braking forces act upon the wheels.

From DE 101 41 274 A1 is known a steering system of a motor vehicle having one yawing regulator wherein the yawing regulator continuously detects a yawing rate which represents the yawing motion of the vehicle and depending thereon forms a control signal which induces a steering motion that counteracts an undesired yawing motion. The control signal is formed, according to the braking state of the vehicle, so that the control signal is preferably formed in case of a regulated braking operation with at least one more reinforcing factor than in the free-wheel braking operation.

Within the scope of DE 102 12 582 A1 is further described a method for regulating the dynamic drive wherein at least one steering engagement is regulated on a vehicle axle and in the scope of which is determined a nominal dynamic drive described at least by a nominal dynamic yaw and a precontrol value of steering angle is determined on the basis of the nominal dynamic drive using a control system pattern. There is further determined the driving state described by at least the yawing rate and at least a correction value of a steering angle based on the deviation of the actual yawing rate from a nominal yawing rate, and the steering engagement is established by the precontrol value of the steering angle and at least one correction value of the steering angle.

In the method known from the prior art within the scope of the pattern series regulation based on the measured yawing rate of the vehicle, the actual friction value of the road has to be determined to form guide parameters. The vehicle steering characteristics must be known which are usually reproduced as linearized stationary meshing pattern and have deviations from the meshing pattern mainly in the area of intensive tire slippages and great dynamic maneuvering. An appraisal of the friction value is, in addition, disadvantageously expensive and can be subject to great uncertainties, depending on the driving situation.

On the other hand, the floating angle has to be calculated or appraised for regulating the floating angle of the vehicle, since in production vehicles the floating angle usually cannot be directly measured due to the high cost of sensors. A calculation of the floating angle, by way of the production sensors currently available, is also subject to relatively great inaccuracy. Furthermore to calculate the floating angle, a timed integration is needed which, due to summarized signal inaccuracies in certain cases, drifts away after a few seconds and has to be assisted with costly logic.

The problem on which the instant invention is based is to outline a method for regulation of the dynamic drive of motor vehicles which overcomes the above mentioned disadvantages of the methods known from the prior art.

### SUMMARY OF THE INVENTION

A method to regulate the dynamic drive of motor vehicles is outlined in which the regulation of the dynamic drive is based on the measured transverse acceleration of the vehicle. In particular, it is proposed that the difference between the calculated transverse acceleration and the measured transverse acceleration be calculated. There is superimposed as function of the difference upon the driver's wish, that is, on the steering angle preset by the drive, an additional wheel steering angle.

### DETAIL DESCRIPTION OF THE INVENTION

In a first embodiment the difference between the calculated transverse acceleration and the measured transverse acceleration is used as criterion for converting the driver's wish under the actual driving conditions. Therefor the difference between a transverse acceleration, calculated according to geometric equations, form the wheel steering angle and the vehicle longitudinal speed (assuming that no transverse slippage occurs on the tires). The actually measured transverse acceleration is formed as criterion A for the transverse load of the vehicle and as criterion for the convertibility of the driver's wish under the actual driving conditions (for example, road-tire friction contact, inherent steering characteristics of the vehicle, load distribution relative to front/rear axles or inner/outer side of the curve). If the measured transverse acceleration is definitely less than the transverse acceleration calculated from the wheel steering angle, this corresponds to high transverse slippage values or oblique angles, which means that the tire transverse forces needed to maintain the engagement can no longer, to a sufficient extent, be turned to the road. For the difference A, a threshold value can be defined or preset according to other parameters (for example, selection of the driving program). Since the characteristic line of the tire transverse force (tire transverse force as function of the oblique angle) beyond a maximum, drops again as the oblique angle further increases, steps has been included in the invention to limit the a steering stop in good time.

This is accomplished, according to the invention, for example, by superimposing on the driver's wish, that is, on the steering angle preset by the driver, an additional positive or negative value of the steering wheel angle as function of the criterion Δ so as thereby to reduce the oblique angle resulting on the front and rear axles. This function can be, for example, a reduction of the wheel steering angle proportional to or integrating the criterion Δ as long as the calculated transverse acceleration is higher than the measured transverse acceleration, or as long as the difference between the calculated transverse acceleration and the measured transverse acceleration exceeds a presetthreshold value. For the case that the wheel steering angle is increased, the steering effort of the driver is thus reduced.

The method is not limited to a steering engagement, but can operate in all systems relevant to dynamic drive such as the input torque distribution via a variable longitudinal distributor and regulatable transverse locks, the rolling support with variable supporting ratio of the forces occurring on the front and rear axles, the variable damping in the wheels suspension and/or the vehicle service brake.

The transverse acceleration can be calculated, for example, according to the following geometric equation:
α_{y}_{_{—}}₁=(ν²_{FZG}δ_{LENK})/wheel base
where: ν_{FZG}=a vehicle reference speed, δ_{ENK}=a steering angle on front wheel.

In one development the required steering force can be increased corresponding to the criterion of convertibility of the driver's wish.

According to another alternative of the method introduced here, the following formula is used, for example, as approximation of a stable, stationary driving situation at low transverse acceleration where the transverse acceleration can be calculated simply via the track curvature from the vehicle longitudinal speed and the yawing rate.
_{y}_{_{—}}₂=84 _{FZG}d/dt(ψ)
where ψ=a vehicle yawing angle, ν_{FZG}=a vehicle longitudinal speed and α_{y}_{_{—}}₂=a transverse acceleration. It is also possible to use other calculation methods known from the prior art, which are based on the vehicle longitudinal speed and the yawing rate. According to the invention, an additional positive or negative value of the steering wheel angle is superimposed on the driver's wish as function of the difference between the measured transverse acceleration and the calculated transverse acceleration.

In this method, the difference A between the measured and the calculated transverse accelerations serves as criterion for an intermittent floating angle construction and consequently for an incipient critical driving situation in which the vehicle yaws to a greater extent or to a lesser extent than would correspond to a slow stationary motion upon its road curve. The threshold value can also be defined as function of other parameters such as the driving program.

For the case that the vehicle dynamically understeers, this indicates a tendency to stalling of the front wheels in which case the high yawing acceleration required by the driver, due to insufficient ground adhesion, can no longer be sufficiently converted to motion. This results in reduced mobility and safety when, at the same time, the maximum tire transverse force characteristic line is exceeded. In the case of oversteering, this indicates a tendency to overspeeding of the vehicle with loss of adhesion on the rear axle.

According to an advantageous development of the invention, such an unstable driving condition is counteracted by a regulator making nominal and actual transverse accelerations coincide. This is achieved by superimposing on the driver's wish an additional (positive or negative value) steering wheel angle as function of the control difference. The control difference can be superimposed directly or only after exceeding a threshold according to the preceding claims. In the overcontrol case, this function can be, for example, a reduction of the wheel steering angle proportional to or integrating the control difference. In the undercontrol case (this is, as a rule, the dynamic drive uncritical case), the mobility of the vehicle can be increased by, prior to the maximum tire transverse force, increasing on the front axle the wheel steering angle for boosting the mobility in which case, when the tire transverse force maximum is exceeded. That is, beyond the tire transverse force maximum, the steering system is again opened (the steering angle is reduced) to making the use of the maximum transverse force of the tire possible.

This alternative of the inventive method, likewise, is not limited to a steering engagement, but can operate all systems relevant to dynamic drive, such as the input torque distribution, via a variable longitudinal distributor and regulatable transverse locks, the rolling support with variable support ratio of the forces occurring on front and rear axles, the variable damping in the wheel suspension and/or the vehicle service brake.

Of special advantage for use in the practice is a superimposition of both introduced alternatives since a certain safety area is adjusted within the scope of the first alternative where an additional wheel steering angle is superimposed on the steering angle preset by the driver as function of the criterion A. While in the second alternative in a critical case, a torsion of the vehicle longitudinal axle is prevented. Both methods can be superimposed preferably proportionally.

By virtue of the inventive idea in critical situations, the driver is assisted by the regulation as a result of its predominantly proportional character. In case of an emergency, it is possible that the regulation be oversteered by a steering engagement on the driver's side (for example, to prevent a collision).

To apply the method, the value of the steering angle and/or of the vehicle yawing rate is needed together with the transverse acceleration. The parameters are available without additional cost, since the sensors needed for steering angles, yawing rate and transverse acceleration are widely used in production vehicle due to the use in brake-based dynamic drive regulations (for example, ESP).

1-17. (canceled)

18. A method of regulating a dynamic drive of a motor vehicle, the method comprising the steps of:
basing regulation of the dynamic drive on a measured transverse acceleration of the vehicle;
calculating a difference between a calculated transverse acceleration and a measured acceleration; and
superimposing one of an additional positive and a negative value of the steering wheel angle on a steering angle, preset by a driver, as function of the difference between the calculated transverse acceleration and the measured acceleration.

19. The method of regulating the dynamic drive of the motor vehicle according to claim 18, further comprising the step of using the difference between the calculated transverse acceleration and the measured transverse acceleration as a criterion for convertibility of a driver's wish under actual driving conditions.

20. The method of regulating the dynamic drive of the motor vehicle according to claim 18, further comprising the step of additionally using a function of the difference between the calculated transverse acceleration and the measured transverse acceleration for control of other aggregates effective in dynamic force.

21. The method of regulating the dynamic drive of the motor vehicle according to claim 20, further comprising the step of controlling, by way of a function of the difference between the calculated transverse acceleration and the measured transverse acceleration, the drive torque via a variable length distributor and regulatable transverse locks, a rolling support with a variable support ratio of the forces occurring on front and rear axles, variable damping in one of a wheel suspension and a vehicle service brake.

22. The method of regulating the dynamic drive of the motor vehicle according to claim 18, further comprising the step of superimposing an additional positive or negative value of a steering wheel angle on the steering angle preset by the driver as function of the criterion when the measured transverse acceleration is lower than the transverse acceleration calculated from the wheel steering angle or the difference exceeds a preset threshold value in order to one or more of reduce an oblique angle on front and rear axles resulting therefrom and to reduce steering effort of the driver.

23. The method of regulating the dynamic drive of the motor vehicle according to claim 22, further comprising the step of one of reducing or increasing the steering wheel angle in proportion to and integrating the difference as long as the calculated transverse acceleration is higher than the measured transverse acceleration or as long as the difference between the calculated transverse acceleration and the measured transverse acceleration exceeds a preset threshold value.

24. The method of regulating the dynamic drive of the motor vehicle according to claim 22, further comprising the step of defining the preset threshold value according to at least one other parameter.

25. The method of regulating the dynamic drive of the motor vehicle according to claim 22, further comprising the step of calculating the transverse acceleration according to a geometric equation comprising:
α_{y}_{_{—}}₁=(ν²_{FZG}δ_{LENK}) wheel base
where: ν_{FZG}=a vehicle reference speed, and
δ_{ENK}=a steering angle of a front wheel.

26. The method of regulating the dynamic drive of the motor vehicle according to claim 18, further comprising the step of calculating the transverse acceleration from a vehicle longitudinal speed and a yawing rate, and an additional wheel steering angle being superimposed on the driver's wish as a function of the difference between the measured transverse acceleration and the calculated transverse acceleration.

27. The method of regulating the dynamic drive of the motor vehicle according to claim 26, further comprising the step of using the difference between the measured transverse acceleration and the calculated transverse acceleration as a criterion for an intermittent angle design and consequently for an incipient critical driving situation.

28. The method of regulating the dynamic drive of the motor vehicle according to claim 26, further comprising the step of coinciding nominal and actual transverse accelerations by means of a regulator, the additional steering wheel angle superimposed on the driver's wish being a function of the control difference.

29. The method of regulating the dynamic drive of the motor vehicle according to claim 26, further comprising the step of one of increasing or reducing the wheel steering angle, in an overcontrolled case, in proportion to and integrating the control difference.

30. The method of regulating the dynamic drive of the motor vehicle according to claim 26, further comprising the steps of increasing steering wheel angle in an undercontrolled case, before a tire transverse force maximum on the front axle, to increase mobility and reducing the steering angle beyond the tire transverse force maximum.

31. The method of regulating the dynamic drive of the motor vehicle according to claim 26, further comprising the step of calculating the transverse acceleration from vehicle longitudinal speed as an approximation to a stable stationary driving situation and yawing rate is calculated via a track curvature.

32. The method of regulating the dynamic drive of the motor vehicle according to claim 31, further comprising the step of calculating the transverse acceleration according to the following formula:
α_{y}_{_{—}}₂=ν_{FZG}d/dt(ψ)
where: ψ=a vehicle yawing angle,
ν_{FZG}=a vehicle longitudinal speed, and
α_{y}_{_{—}}₂=a transverse acceleration.

33. The method of regulating the dynamic drive of the motor vehicle according to claim 26, further comprising the step of applying in addition to the method for dynamic drive regulation, the effects of both methods being superimposed.

34. The method of regulating the dynamic drive of the motor vehicle according to claim 33, further comprising the step of proportionally effecting the superimposition.
